(19) United States
(12) Patent Application Publication
(10) Pub. No.: US 2013/0093655 A1
(43) Pub. Date: Apr. 18, 2013

(54) USER INTERFACE, APPLIANCE OF HOUSEHOLD OR INDUSTRIAL TYPE AND ARRANGEMENT OF APPLIANCES

(71) Applicants: Eva Holzgreve, Pordenone (IT); Marc Tajariol, Cordenons (IT); Jochen Holzinger, Rothenburg (DE)

(72) Inventors: Eva Holzgreve, Pordenone (IT); Marc Tajariol, Cordenons (IT); Jochen Holzinger, Rothenburg (DE)

(73) Assignee: ELECTROLUX HOME PRODUCTS CORPORATION N.V., Brussel (BE)

(21) Appl. No.: 13/640,550

(22) PCT Filed: May 13, 2011
(86) PCT No.: PCT/EP2011/002367

§ 371 Date: Oct. 11, 2012

(30) Foreign Application Priority Data
May 28, 2010 (EP) 10005552.4

(51) Int. Cl. G09G 3/32

(52) U.S. Cl. CPC G09G 3/32
USPC 345/82

(57) ABSTRACT

The present application in particular is directed to a user interface 1 for an appliance of household or industrial type. The user interface 1 comprises a display unit having a display area 2 with at least one of an active and passive display element 3, 4. The display unit is arranged underneath an at least partially transparent cover 5, at least one preferably elongate and bar shaped, transparent optical element 8 being arranged on the transparent cover 5 on a side averted from the display unit, covering at least partially the display area 2.

The present application is directed to a user interface, an appliance of household or industrial type and an arrangement of appliances.

A user interface for a household appliance is known from DE 20 2006 006 612 U1, for example. The user interface comprises a front wall covering display elements. The front wall thickness decreases at its margins thus generating a loupe or 3D-effect with respect to display signs to be visualized to a user of the appliance.

It is an object of the invention to provide an alternative user interface for an appliance of household or industrial type, which is able to provide at least one of a loupe or 3D-effect for display signs to be visualized to a user. Further, an appliance of household or industrial type and an arrangement of appliances shall be provided.

This object is achieved by independent claims 1, 8 and 10. Embodiments of the invention result from dependent claims.

According to independent claim 1, a user interface for an appliance of household or industrial type is provided. The user interface comprises at least one display unit having a display area with at least one of an active and passive display element.

An active display element may comprise one or more, e. g. an array of, light emitting diodes (LED's), liquid crystal display (LCD) elements or 7-segment display elements. In particular such display elements make it possible to display various and varying information related to respective operational states of the appliance and the like. In contrast to such dynamic display elements, a passive display element may be a static display element, a printing or the like for example, for indicating fixed invariant information, such as general information like a brand name and the like. A passive display element may be combined with a background illumination allowing a respective display sign, such as the brand name, to be visible when illuminated and be hidden when not illuminated.

The display unit is arranged underneath a cover being at least partially transparent. The cover can serve to protect the display unit from environmental influences such as dirt and moisture. The cover may be of glass, a glass ceramic or a plastic material, for example.

Further, at least one, preferably elongate and bar shaped, transparent optical element is arranged on the transparent cover. The optical element is positioned on a side of the transparent cover averted from the display unit. The optical element covers the display area at least partially. Preferably, the optical element covers all display signs provided with the display area.

Bar shaped shall in particular mean, that the longitudinal dimension of the optical element is large compared to the lateral dimension thereof.

By adequately designing the optical element, a loupe or 3D-effect may be obtained, improving perceptibility of the display signs even from remote locations and a variety of different viewing locations and viewing angles. In particular it is possible to adequately scale up, scale down, distort and rectify display signs intended to be presented to a user. The optical element may be adapted such that the aforementioned optical effects are obtained for respective, in particular a predefined set or range of, viewing locations occurring during normal operation of the appliance.

In particular, a loupe and/or 3D-effect, especially the aforementioned optical effects, may be obtained if at least one segment of the optical element is of trapezoid, convex, oval or triangular cross section. More preferable, at least one long side of the at least one segment of trapezoid or triangular cross section is of convex type, which shall mean that a respective surface area is bent outwards.

The optical element may further be adapted such that light emanating from display elements is refracted upon passing the optical element. Here, desired aesthetic effects may be obtained. w However, it is also possible that refraction is used in order to obtain enhanced visibility and perceptibility at respective viewing positions and angles. In addition, optical elements having the aforementioned optical properties and shapes may enhance brightness and brilliance of display signs visible through the optical element.

As already indicated, the display unit may, in one configuration, comprise at least one of at least one of an LED, LCD, 7-segment display and printed display element. It is preferred that the display elements are arranged in a line extending parallel to the longitudinal direction of the optical element. In this way the display elements can easily be covered by the bar shaped optical element. It shall be noted that such an arrangement leads to a uniform, regular and clearly laid out display area of favourable design.

In a further configuration, the optical element is made from glass, in particular borosilicate glass, a glass ceramic material, an acrylic glass material or a plastic material. The acrylic glass material may be PMMA (poly-methylmethacrylate) or analogous materials, for example. Such materials are well suitable to implement the above-identified optical effects, and have comparatively high mechanical and heat impact resistance.

In a further configuration, at least one of a long side and face side of the optical element comprises at least one bevelled edge. Bevelled edges may be used to enhance the outer appearance of the optical element or to delimit or sub-divide the overall vision angle to certain dihedral angles. For example, by using bevelled face side edges, light emission through the face sides can be suppressed. This may be of advantage if several optical elements are arranged in a line with respect to the longitudinal direction thereof, as optical cross talk between adjacent optical elements can be suppressed.

With respect to the fixation of the at least one optical element, there are several preferred possibilities such as attaching the optical element to the transparent cover via glue, preferably transparent glue, more preferably UV curing glue. Using glue is a comparatively simple way of fixation while providing satisfactory fixation force.

In a further configuration, an optical layer for altering the shade or color of the display elements shining through the optical element may be provided between the transparent cover and the optical element. Note that also exposed outer surfaces of the optical element may comprise such an optical layer. The optical layer preferably contains silver or chromium. In a further embodiment the optical element can have a concave or inwardly curved surface directed anyway from the transparent cover instead of a flat surface. By that an intermediate space is formed between the transparent cover and the lower surface of the optical element.

According to independent claim 8, an appliance of household or industrial type, in particular a cooking appliance or a cooking hob, is provided. The appliance comprises at least one user interface as described above, in particular a user interface according to any of the above-described configurations. As to advantages and advantageous effects, reference is made to respective discussion above.

In the case of a cooking appliance, in particular cooking hob, it is preferred that the optical element separates the respective at least one user interface from a cooking area of the appliance. Here, the transparent cover may be a glass or glass ceramic cooking hob plate. As the optical element is attached to the transparent cover, and hence may project therefrom, it may function as a retaining element or mechanical barrier for cooking utensils and the like.

According to independent claim 10, an arrangement comprising several appliances of household or industrial type is provided. Each of the appliances comprises a user interface as described above, in particular a user interface according to any of the above-described configurations. With the arrangement, user interfaces of at least two adjacent appliances being arranged in a line, in particular such that respective optical elements are aligned with respect to their longitudinal extension. In this way a uniform optical display area virtually spreading over adjacent appliances can be obtained, improving and easing perceptibility of respective display signs to a user. In particular, all the display signs of the appliances can be projected to common, convenient, i. e. more user-friendly, planes or dihedral angles.

With respect to the ordinary operational state of the appliances the optical elements of adjacent appliances can be aligned either in vertical or horizontal direction. Here, orientation of the optical elements more or less depends on the mutual arrangement of various display signs of different, adjacent user interfaces. Vertical or horizontal orientation may be selected in order to provide optimal perceptibility and a more or less unique display interface with appliances arranged side-by-side and on top of each other, respectively.

Embodiments of the invention will now be described in connection with the annexed figures, in which

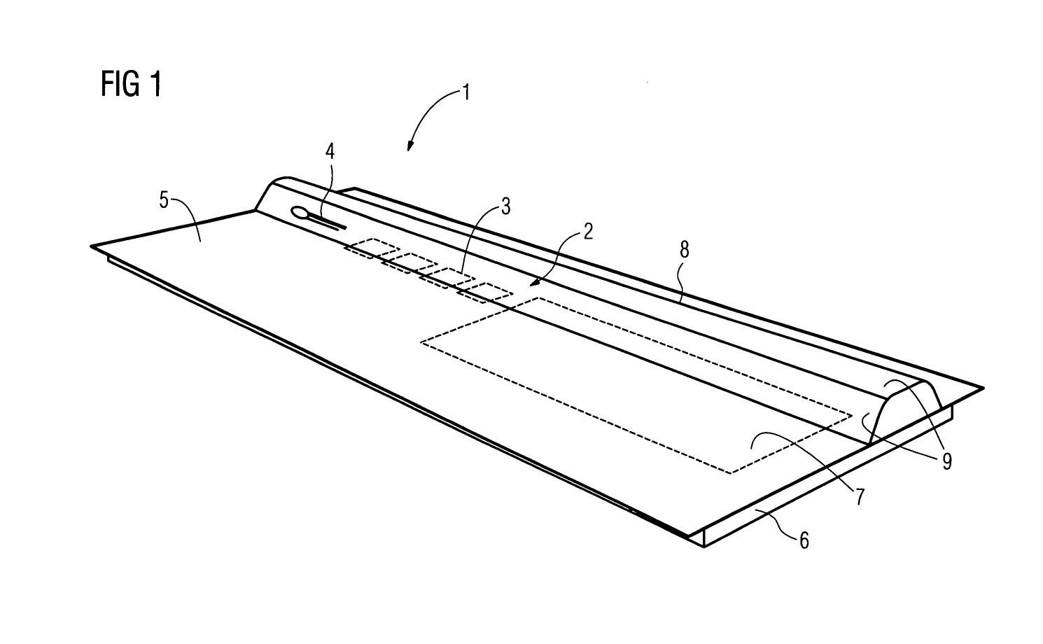

FIG. 1 shows a schematic, perspective representation of a user interface;

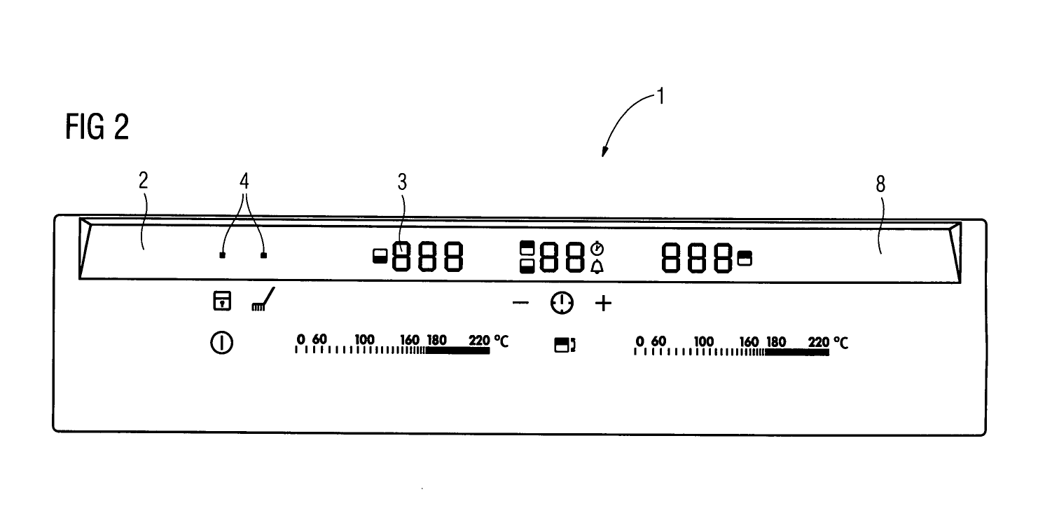

FIG. 2 shows a top view of a user interface;

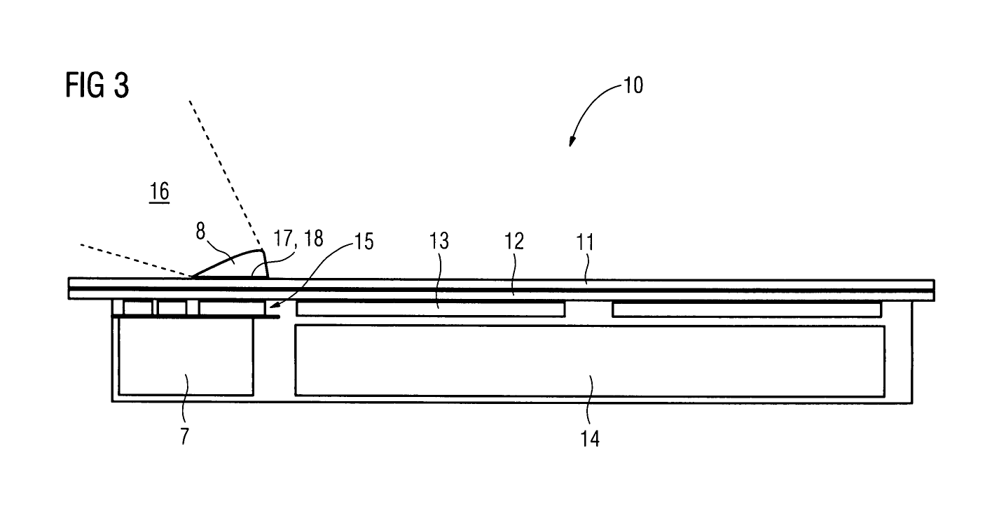

FIG. 3 shows a side view of a cooking hob comprising a user interface; and

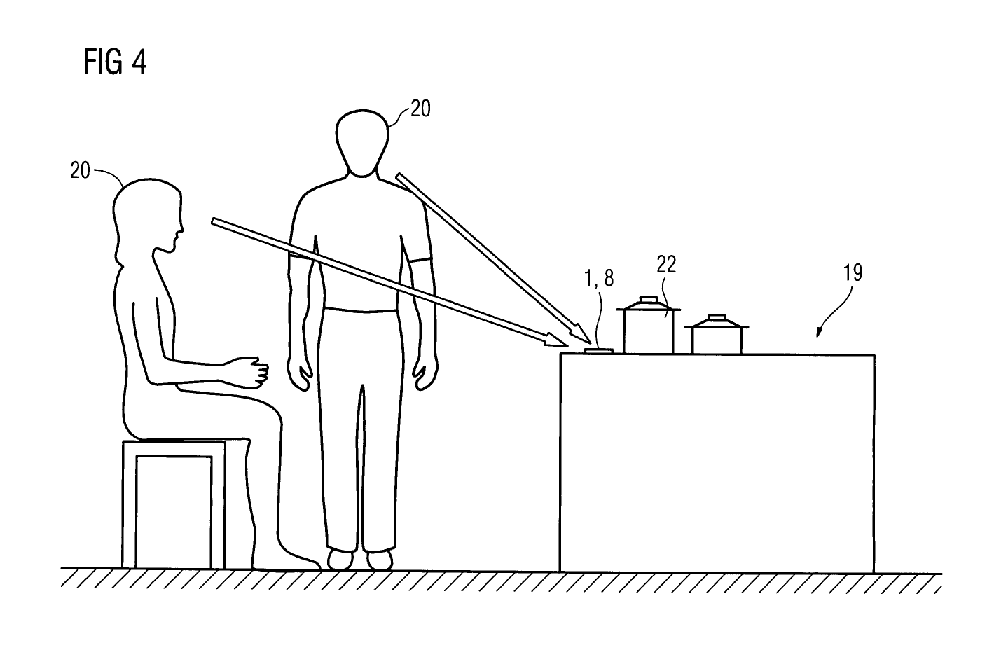

FIG. 4 illustrates a scene with a household cooking oven and two users glancing at a user interface of the oven.

The invention will be described in connection with a household cooking oven. However, this shall not be construed as limiting the scope of the invention. Rather, the invention can be applied and used in connection with a variety of similar or other appliances of household and industrial application, for example washing machines, dishwashers, microwave ovens, refrigerators, freezers and the like.

If not otherwise stated like elements are denoted by like reference signs throughout the figures. The figures may not be true to scale, and scales of different figures may be different.

FIG. 1 shows a schematic, perspective representation of a user interface 1 of a household cooking oven. The user interface 1 comprises a display unit having a display area 2 with several active display elements 3 and a passive display element 4. The user interface 1 is arranged below a transparent cover 5 which may be made from glass, glass ceramic or other suitable material. Note that the transparent cover 5 may be shaded, colored or coated such that it is transparent at least in regions covering the display signs. Transparent shall mean that light or other display signs can shine through the cover and be adequately recognized by a user.

An active display element 3 may be a LED light source or an array of LED light sources for indicating a certain operational state, an LED display, a LCD display or a 7-segment display. A passive display element 4 may be a printing applied to the lower or upper side of the transparent cover 5. Passive display elements 4 may be illuminated via a backlight, a LED backlight for example.

Outside or, where applicable, within the display area 2, the transparent cover 5 may comprise indicator elements or bars, sliders, gauges, slide controls, knobs, rotary knobs, switches and other elements. Some examples thereof are shown in connection with FIG. 2.

The active and passive display elements 3, 4 together with display electronics 7 are arranged in an electronic box 6 attached to the lower side of the transparent cover 5. The active and passive display elements 3, 4 and the display electronics 7 make up a display unit of the oven.

On a side of the transparent cover 5 averted from the display unit, in the present case the upper side of the cover 5, an elongate, bar shaped and transparent optical element 8 is attached to the transparent cover 5. The optical element 8 covers at least the display area. However, in the present case the optical element 8 extends over the whole length of the transparent cover 5. Note that in a region covered by the optical element 8 and lying outside the active display elements 3 further passive display elements can be arranged.

The optical element 8 in the present case is an elongate bar having a trapezoid cross section. Note that other cross-sectional geometries may be used such as triangular, oval, circular or segments thereof. Long sides 9 of the optical element, at least the front and top long side, are convex to the outside.

The optical element 8 is shaped and its surfaces are curved in such a manner that the active and passive display elements 3, 4 are well visible from a range of viewing angles and viewing positions. By adequately adapting the shape and curvatures of the optical element 8, good perceptibility, brilliance and brightness of the active and passive display signs 3, 4 can be can be obtained. Further, the range of viewing angles can be adapted to match viewing angles at proximal or remote viewing positions.

FIG. 2 shows a top view of a user interface 1. The display unit in the present case comprises several passive display elements 4, such as printings, back illuminated printings, and single LED signals for indicating miscellaneous operational states of the oven or cooking hob. Further, the display unit comprises several active display elements 3 which in the present case are 7-segment displays. However, any other kind of active display elements such as LED and LCD displays can be used. The active and passive display elements 3, 4 are arranged in a line presently extending in horizontal direction.

The optical element 8 covers the linear arrangement of active and passive display elements 3, 4 and extends over nearly the whole length of the user interface 1. The length and coverage of the optical element 8 may in principle be selected arbitrarily. Instead of using one single optical element 8, several optical elements can be used to selectively cover display areas 2 of the user interface 1.

Below the display area 2 there are, and may be provided further buttons, push-buttons, touch sensitive elements, sliders, indication elements and the like. Buttons, touch sensitive elements and sliders may be adapted such that a user can set and control operational parameters of the appliance.

The cross section of the optical element 8 shown in FIG. 2 differs from the one shown in FIG. 1. The upper part of the optical element 8 is of triangular shape, wherein the triangle hypotenuse is konvex to the outside. The top, longitudinal edge of the optical element 8 is bevelled, which is for design reasons as well as for delimiting the display range to a predefined dihedral angle. Note that also the face sides of the optical element 8 can be bevelled for the same reasons or other.

FIG. 3 shows a side view of a cooking hob 10 comprising a user interface 1. The user interface 1 is arranged below a ceramic glass plate 11 which serves both as a cooking plate and transparent cover 5. On the lower side of the ceramic glass plate 11 there may be provided an additional layer 12 for providing additional printings, optical elements and designs, in particular color printings, intended to shine through the glass plate 11 both in the region of the user interface 1 and in the region of the cooking area.

The cooking hob 10 further comprises several heating units 13 and respective heating electronics and controls 14. In a distance from the heating units 13 the electronic box 6 is mounted to the lower side of the cover 5 which in the present case comprises the glass plate 11 and the additional layer 12.

Buttons, push-buttons, touch sensitive elements, sliders and/or indication elements and the like are mounted to the lower side of the cover 5 together with the display unit 15. The display unit 15 comprises active and passive display elements 3, 4 as shown and described in connection with FIGS. 1 and 2. At the side of the glass plate 11 averted from the display unit 15, the optical element 8 is attached to. The optical element 8 is sized and arranged such that it at least covers the active and passive display elements 3 and 4.

The optical element 8 in the present case is of triangular cross section with the hypotenuse being konvex to the outside. As becomes clear, the optical element 8 brings about a loupe or 3D-effect improving perceptibility of the passive and active display elements 3, 4 within a viewing region 16 indicated by dashed lines in FIG. 3. The optical element 8 preferably is made from glass, in particular borosilicate glass, a glass ceramic material or a plastic material.

The optical element 8 is attached to the ceramic glass plate 11 via UV curable glue 17. Other means of attachment, such for example mechanical attachments, are conceivable and lie within the scope of the present invention.

An optical layer 18 for altering the shade or color of the active and passive display elements 3, 4 shining through the optical element 8 is provided between the ceramic glass plate 11 and the optical element 8. The optical layer 18 can be used to further increase perceptibility of the active and passive display elements 3, 4 and preferably contains silver or chromium.

FIG. 4 illustrates a scene with a household cooking oven 19 and two users 20 glancing at a user interface 1 of the oven 19, which is indicated by two solid arrows. As is indicated, the active and passive display elements 3, 4 are well perceivable from a multitude of different viewing positions and viewing angles due to the optical effect of the bar shaped optical element 8. This is, inter alia, due to a loupe and/or 3D-effect obtained via the optical element 8.

Also, it becomes obvious from FIG. 3 and FIG. 4 that the optical element 8 separates the user interface from a cooking area 21. In particular, the optical element 8 serves as a mechanical barrier between the user interface 1 and the cooking area 21. Hence, cooking utensils 22 can be prevented from being, in particular unintentionally, pushed from the cooking area 21 to the user interface 1 and off the cooking oven 19.

If several appliances are arranged side to side or on top of each other, respective user interfaces 1 can be arranged and adapted such that their user interfaces 1 are arranged in line. In particular, it is possible that respective optical elements 8 are aligned with respect to their longitudinal extension leading to a uniform display area that can be observed at a glance. Dependent on the arrangement of the appliances, may it be side to side or on top of each other, the user interfaces 1 and respective optical elements 8 can run in vertical or horizontal direction. Appliances that can be arranged in succession are for example cooking ovens 19, dish washers, microwave ovens, refrigerators, freezers and the like.

In all it becomes clear that the user interface as proposed herein is able to provide good perceptibility of display signs to be visualized to a user. In particular, at least one of a loupe or 3D-effect contributes to enhanced perceptibility and display quality.

### LIST OF REFERENCE NUMERALS

1 user interface
2 display area
3 active display element
4 passive display element
5 transparent cover
6 electronic box
7 display electronics
8 optical element
9 long side
10 cooking hob
11 ceramic glass plate
12 additional layer
13 heating unit
14 heating controls
15 display unit
16 viewing region
17 glue
18 optical layer
19 cooking oven
20 user
21 cooking area
22 cooking utensil

1. User interface (1) for an appliance (19) of household or industrial type, comprising at least one display unit (15) having a display area (2) with at least one of an active and passive display element (3, 4), the display unit (15) being arranged underneath an at least partially transparent cover (5), at least one, preferably elongate and bar shaped, transparent optical element (8) being arranged on the transparent cover (5) on a side averted from the display unit (15), covering at least partially the display area (2).

2. User interface (1) according to claim 1, the optical element (8) comprising at least one segment of trapezoid, konvex, oval or triangular cross section, wherein at least one long side (9) of the at least one segment of trapezoid of triangular cross section preferably is of convex type.

3. User interface (1) according to claim 1, the display unit (15) comprising at least one of an LED, LCD, 7-segment display (3) and printed display element (4), wherein display elements (3, 4) preferably are arranged in a line extending parallel to the longitudinal direction of the optical element (8).

4. User interface (1) according to claim 1, the optical element (8) being made from glass, in particular borosilicate glass, a glass ceramic material or plastic material.

5. User interface (1) according to claim 1, at least one of a long side and face side of the optical element (8) comprising at least one bevelled edge.

6. User interface (1) according to claim 1, the optical element (8) being attached to the transparent cover (5) via glue (17), preferably transparent glue, in particular UV curing glue.

7. User interface (1) according to claim 1, an optical layer (18) for altering the shade or color of the display elements (3, 4) shining through the optical element (8) is provided between the transparent cover (5) and the optical element (8), the optical layer (18) preferably containing silver or chromium.

8. Appliance of household or industrial type, in particular cooking appliance (19) or cooking hob (10), comprising at least one user interface (1) according to claim 1.

9. Appliance according to claim 8, wherein the optical element (8) separates the respective at least one user interface (1) from a cooking area (21).

10. Arrangement comprising several appliances (19) of household or industrial type, each of the appliances (19) having a user interface (1) according to claim 1, wherein user interfaces (1) of at least two adjacent appliances (19) being arranged in a line, in particular such that respective optical elements (8) are aligned with respect to their longitudinal extension.

11. Arrangement according to claim 10, wherein optical elements (8) of adjacent appliances (19) are aligned in vertical or horizontal direction.
